(19) United States
(12) Patent Application Publication
(10) Pub. No.: US 2014/0074667 A1
(43) Pub. Date: Mar. 13, 2014

(54) System and Method for Inventory Control of Mobile Assets

(71) Applicant: Michael D. SMITH, Hillsboro, OR (US)

(72) Inventor: Michael D. SMITH, Hillsboro, OR (US)

(21) Appl. No.: 13/610,603

(22) Filed: Sep. 11, 2012

(51) Int. Cl. G06Q 10/08; H04Q 5/22; G01S 3/02

(52) U.S. Cl. 705/28; 342/451; 340/10.1

(57) ABSTRACT

A radio-frequency identification (“RFID”)-based asset tracking system uses a mobile RFID reader to move among stationary assets and communicate with RFID tags attached to the assets. The mobile RFID reader has means for estimating its own location, so the location of a tagged asset can also be estimated by reference to the RFID reader's location when the RFID tag was seen. Location and tag information can be reported back to a central database in real time, or collected and uploaded to the database when the mobile RFID reader returns to a base station. The systems can be used to keep track of vehicles on a dealer's lot or in a warehouse or parking structure.

### CONTINUITY AND CLAIM OF PRIORITY

This is an original U.S. patent application.

### FIELD

The invention relates to automated electronic systems that are uniquely adapted for managing assets in a business that deals with vehicles. In particular, the invention relates to wireless systems for monitoring locations of vehicles that are in the custody of the system operator.

### BACKGROUND

Most businesses have some physical assets that they use in their operations. They may have equipment that they use to provide services, or the assets may be inventory to be sold to customers. In either case (and in hybrid cases where a business has both its own equipment and inventory for sale), it is important to be able to keep track of the assets: where they are, how many there are and so forth. Of course, the broad range of things that a business could have as an asset (from gases and liquids to cows and fork lifts) and the relative value of an asset to the cost of keeping track of it, gives rise to a variety of inventory management methods.

One technical solution that has found applications in many different industries is Radio-Frequency Identification (“RFID”) tags. An RFID tag is a device that can interact with another device wirelessly, using radio-frequency signals. Many RFID tags are small and inexpensive, so they can be attached to an item to be tracked, and a reader can be configured to signal an inventory control system when the item passes nearby. Anti-theft systems in retail stores and book checkout systems in libraries are examples of this sort of application.

There are a number of variables that can be adjusted to adapt the components of an RFID system to a particular application. In general, an RFID system includes:
Transponder: the “tag,” which may be passive (no battery, powered by the energy of an incoming radio signal), active (with battery or similar power source), or active/passive (with battery, but operated passively some of the time to extend battery life);
Transceiver: a radio device to receive a signal from the transponder, and to transmit operating power (or send an activating signal) to passive or active/passive transponders;
Reader: a signal processing unit to interpret the signal from a transponder and convert it to a form suitable for use in the inventory-control system; and
Software: computer software to receive information from the reader and maintain inventory data according to the needs of the business.

Although an RFID system has only a modest number of logical components, and new applications can sometimes be implemented by copying and adapting an existing system, engineers regularly encounter challenges that complicate the deployment of a new RFID-based inventory management system. In these cases, improved reference systems can provide substantial benefits for designers and implementers.

### SUMMARY

Embodiments of the system provide reliable asset location for large, mobile and numerous assets such as vehicles (e.g., cars and trucks) in extended lots and warehouses.

### BRIEF DESCRIPTION OF DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIG. 1 shows a sample auto dealership where an embodiment of the invention is installed.

FIG. 2 shows a block diagram of a basic mobile data collection unit.

FIG. 3 outlines operations according to an embodiment of the invention.

FIG. 4 shows components of a preferred embodiment of the invention.

FIG. 5 is a flow chart outlining operations of a hybrid embodiment of the invention.

FIG. 6 shows how successive reports from a particular RFID tag can be interpreted by a system implementing an embodiment of the invention.

### DETAILED DESCRIPTION

Currently, there are thousands of car dealerships nationwide which rely on physical inventory systems that are time- and labor-intensive, at a significant cost to the dealership. In addition, existing systems cannot provide real-time information, and errors or outdated information may be difficult to correct. By adopting the RFID-based system described herein, a dealership can reduce its costs and improve the accuracy of its inventory information. Specific, tangible benefits include the ability to locate any vehicle quickly (for example, in response to a demand from a lender for inspection of collateral or to deliver the vehicle to a customer); and relaxation of policy-based inventory management rules (error-prone manual logging requirements may be eliminated).

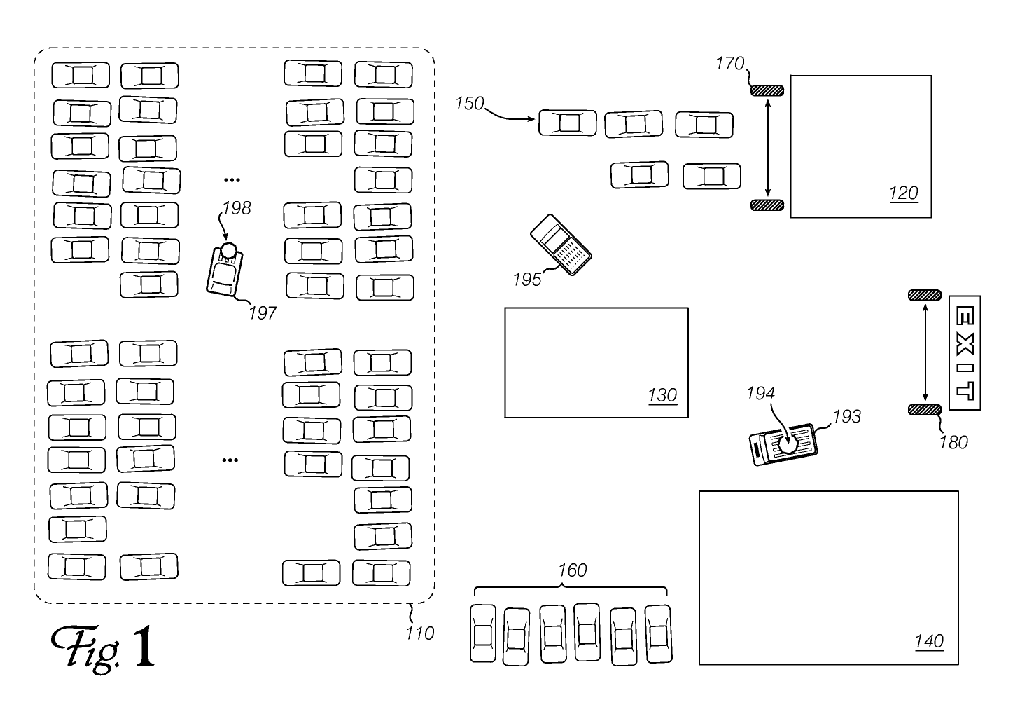

FIG. 1 represents elements found in a typical dealership where an embodiment of the invention may be deployed. A large proportion of the area of the dealership may be dedicated to inventory storage: element 110 represents such a parking lot. A busy dealership may have custody of several thousand vehicles at any given time, which may be distributed over one large or several smaller lots. In addition to the storage lot(s), a dealership may have facilities such as a cleaning and detailing structure 120, maintenance and repair bays 130, or showroom 140. Inventory vehicles may be moved from place to place (e.g., 150, 160) for service, delivery preparation, or other reasons. In addition, such vehicles may not be returned to the same storage location after an excursion.

A facility employing a prior-art RFID system may have stationary RFID tag readers at predetermined locations (e.g., 170, 180) and an inventory control system may be notified when a tagged vehicle passes near such a reader. These systems are of no use for finding a vehicle when it is not near a reader. Attempts to extend stationary-reader systems often focus on deploying additional stationary readers to improve coverage, but (in addition to the added expense) these systems experience maintenance-related degradation as the readers—which are often located in harsh service environments—succumb to heat, moisture or electrical problems.

Embodiments of the invention capitalize on the fact that auto dealerships (and other enterprises that deal with large numbers of vehicles) usually employ many of their own (non-inventory) vehicles 193, 195, 197 to move people and equipment among the tagged cars. By equipping one or more of these vehicles with the mobile system described below (and depicted in FIG. 1 at 194 and 198), an improved inventory tracking system can be implemented.

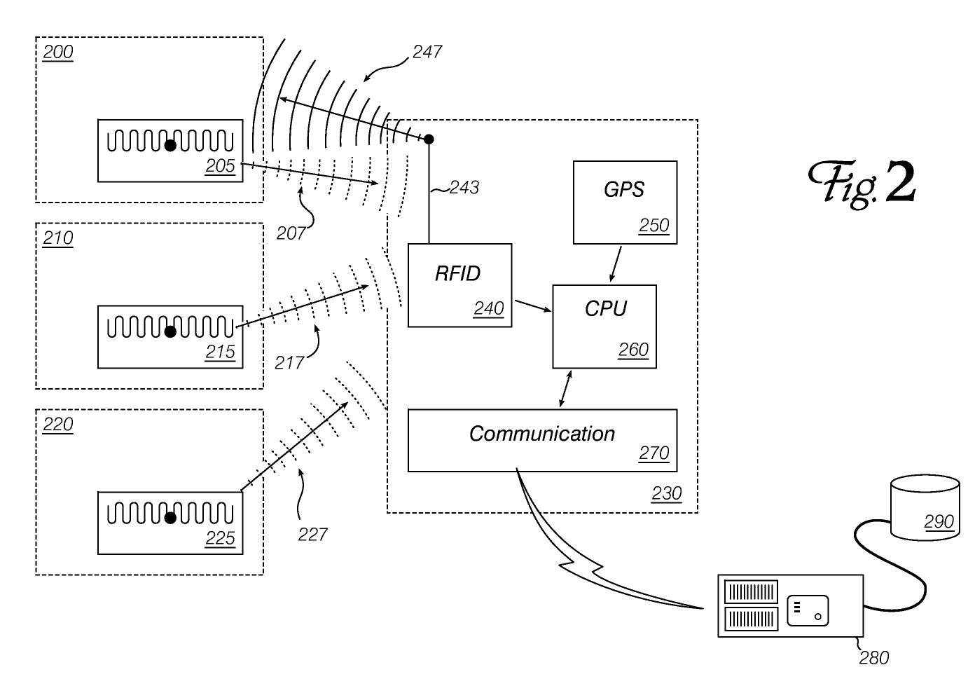

FIG. 2 shows a system functional block diagram of components that interact in an embodiment of the invention. A plurality of assets 200, 210, 220 (e.g., inventory vehicles at a car dealership) are fitted with RFID tags 205, 215 and 225, respectively. Each RFID tag has a unique identifier that it will report when queried, and so each tagged asset can be distinguished from all others.

Another vehicle is equipped with a mobile data collection unit 230, comprising an RFID transceiver 240 to communicate with the RFID tags 205, 215, 225; means for determining or estimating the location of the mobile data collection unit (shown here as GPS 250); a computer (“central processing unit” or “CPU”) 260 for correlating RFID tag responses with location estimates; and a communication interface 270 for reporting asset location information to a base station 280, which stores the information in a database 290.

The mobile data collection unit of FIG. 2 has a Global Positioning System (“GPS”) receiver 250 to provide location estimates for correlation with RFID tag responses. However, other means of determining or estimating the location of the mobile data collection unit may also be used. For example, if assets are stored indoors (e.g., in a multi-storey parking structure), GPS signals may be attenuated or unavailable. In lieu of GPS, an embodiment may place identifying marks on the floor or ceiling where they can be read by a sensor in the data collection unit. Such marks serve the same purpose in an embodiment as GPS in an outdoor implementation: providing a way of estimating the location of the mobile unit when a response from an RFID tag is received. Other known methods of estimating location within a space, such as triangulation from ultrasonic sources whose positions are known, may also be effective. Embodiments may combine multiple techniques for determining (or estimating) location.

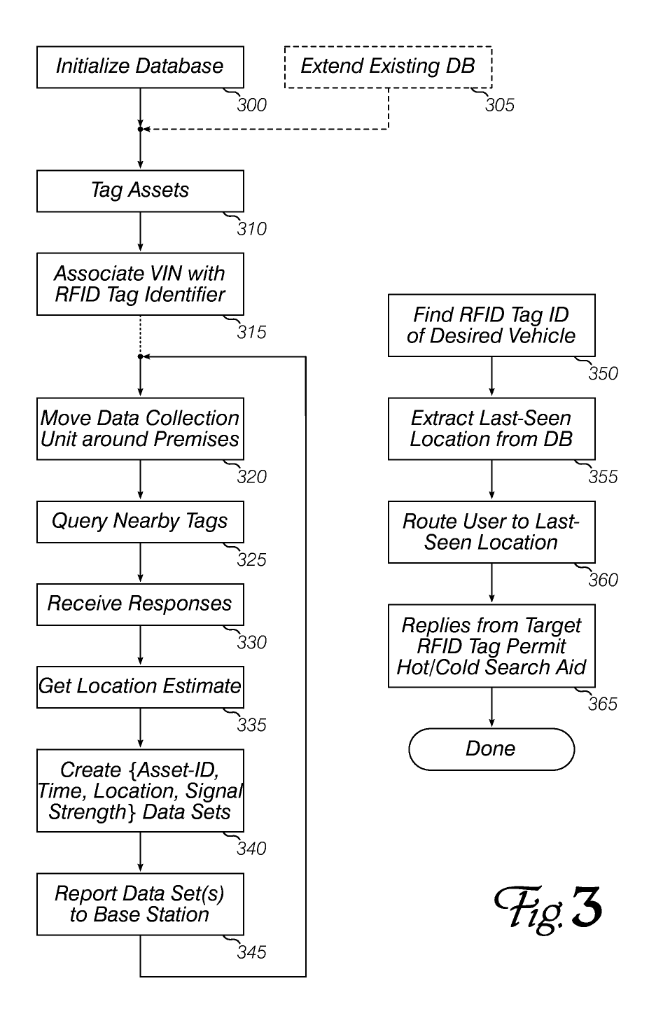

FIG. 3 is a flow chart outlining activities and operations involved in setting up and using an embodiment of the invention. The first step is to initialize a database to store the asset-location information produced and updated during operation (300). (Alternatively, an existing inventory-control database can be augmented with fields to store this information, or simply provided with interface functions to store and retrieve the information in already-existing database fields (305).)

Next, assets to be tracked are enrolled into the system by “tagging” them (attaching an RFID tag) (310) and entering information in the database to correlate the unique ID of the tag with an identifier of the asset (e.g., a serial number or Vehicle Identification Number, “VIN”) (315). Once a vehicle is tagged and enrolled, it may be moved about the premises freely and stored wherever it is convenient to do so.

Independently of vehicle enrollment, one or more mobile data collection units with capabilities like the system described in reference to FIG. 2, are carried about the dealership's grounds (320). Since the data collection units are relatively small and lightweight, and do not have unusually large power demands, a light vehicle such as an electric golf cart—or even a modified bicycle—can be used to carry the data collection units around. These excursions may be dedicated, aisle-by-aisle sweeps made for the principal purpose of refreshing inventory information, but in many installations, there is enough service traffic through various areas of the dealership that information can be collected simply by equipping service vehicles with mobile data collection units and accepting the data opportunistically, as it becomes available while the service vehicle is used for its normal purposes. In either case, the system operates as follows:

The mobile listens for the RFID tags within its range. Some tags may automatically transmit their ID and other tags may need to receive a query or ping (325) in order to transmit their ID, and receives responses thereto (330). Responses may include the RFID tag identification code and other information about the tag (such as its battery state, if it is an active or active/passive device). The mobile unit will also note the signal strength of the response, since the strength may be correlated with the distance between the mobile unit and the tag. In addition, as the mobile unit is moved about, it uses its location-estimating means (e.g., a GPS receiver, visual reference mark detector or triangulation system) to estimate its current location (335). Thus, when a tag response is received, it can be associated with an estimate of the mobile unit's location and a time of response to create a data set comprising the tag ID, tag signal strength, the location and the time (340). In essence, the data say “the asset with RFID tag #N was near location (X, Y) at time T.” (Note that the location estimate is that of the mobile unit, and not of the tagged asset itself. The system can make a secondary estimate of the asset location, based on the mobile unit's location and characteristics of the RFID reader/tag interaction, but an advantage of embodiments of the present invention is that they create and maintain records of probable asset location, without requiring expensive location-determining equipment to be installed on each asset.)

The information in these ID/strength/location/time data may be relayed back to a base station for recording in the inventory database immediately (e.g., via a cell phone or WiFi connection) (345), or stored temporarily in the mobile unit's local memory until a batch of data sets can be uploaded at once.

The data collected (and updated) through the foregoing procedure can be used to find a tagged asset, as follows: first, the database is queried to find the RFID tag associated with the desired asset (350). The location from the most-recently-recorded data set is also retrieved (355). Using this information, the same hardware described above can be used “in reverse,” to direct the service vehicle carrying the mobile data collection unit to the last-seen location (360). As the vehicle approaches the location, the RFID query/response apparatus may note signals from the RFID tag of the asset being sought and the signal strength of the replies may be used to provide range information (“hot/cold” indication: getting closer to or further from the tag) to the user (365). Range information may be communicated to the user by, for example, increasing a pitch of a signal tone as the range decreases, and/or pulsing a “beep” tone more quickly as the range decreases. (Increasing range, by contrast, might produce a lower-frequency tone and/or a less-frequent “beep” pulse.)

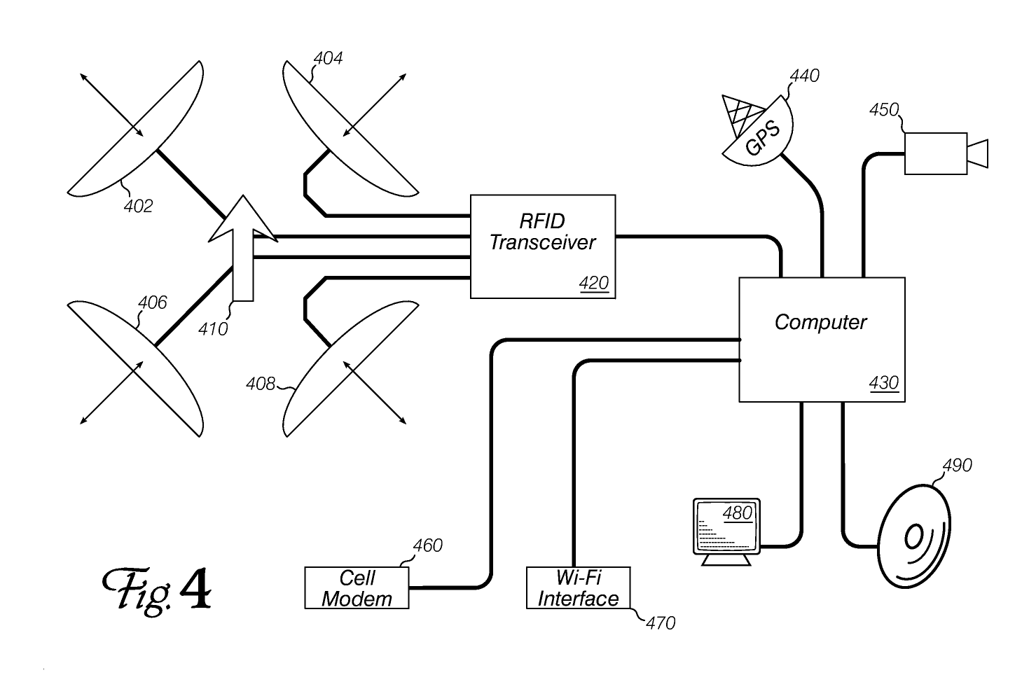

FIG. 4 shows a block diagram of a preferred embodiment of the mobile data collection unit. In this implementation, a plurality of directional RFID antennas 402-408 are arranged so that their axes of greatest signal sensitivity are oriented approximately diagonally to the mobile unit's normal direction of travel (410). Active antennas with physical or electronic features to enhance their sensitivity may be useful in some installations. The antennas are driven by, and return response signals to, RFID transceiver 420. Transceiver 420 may include an amplifier to increase the power of the outgoing query pulses. Multiple directional antennas allow the system to compute improved localization information, particularly when the signals from the multiple antennas are combined with information about the motion of the service vehicle. For example, a tag whose response is strongest at the left front antenna is probably to the left and ahead of the vehicle. If, as the service vehicle advances, the left rear signal becomes stronger, then it is likely that the service vehicle is passing by the tagged vehicle, which can probably be found parked to the left of the service vehicle's present location.

Signal data from the antennas (RFID tag identifiers and signal strength) are provided to a programmable computer 430, which coordinates the operations of the embodiment under the control of instructions and data stored in memory or on disk.

Location information may be provided by a GPS receiver 440, a video camera 450, or another system for sensing the location of the mobile unit. Computer 430 may report asset location information it discovers, or obtain information to help direct the service vehicle to a desired asset, by communicating with base system and database via a cell modem 460 or a wireless (“WiFi”) interface 470. In some embodiments, the mobile unit may be programmed with a copy of the database via a wireless or wired interface (e.g., cell, WiFi, Ethernet or USB cable) and thereafter operate autonomously (albeit without real-time information updates from other mobile units) until the next time a connection can be made to report assets encountered during operations.

Computer 430 may also be equipped with a display 480 and/or audio system (speaker 490) to present information to the operator of the service vehicle. A keyboard, mouse, touch screen or similar interface (not shown) may allow the operator to control the system, request directions to a particular vehicle, etc.

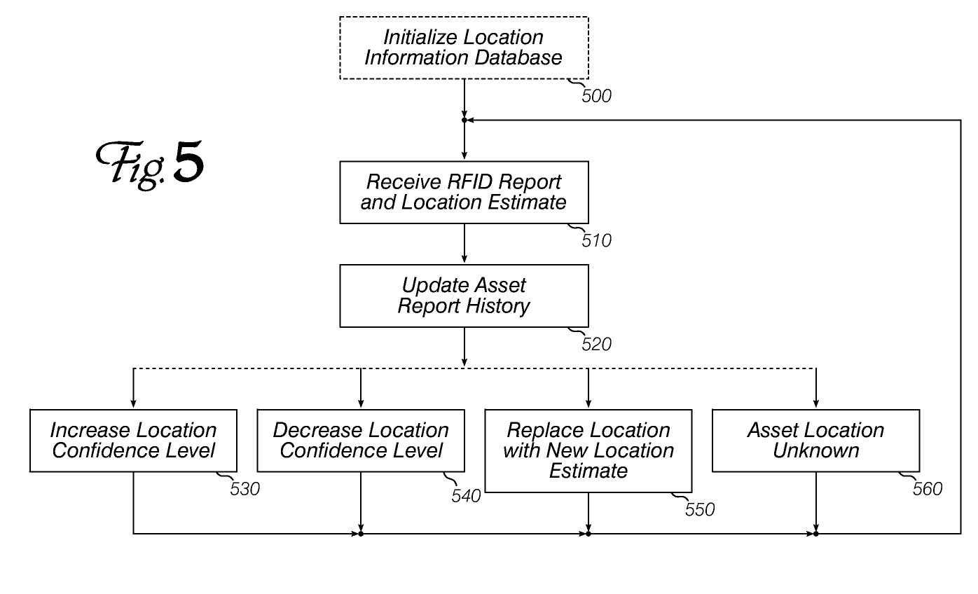

An embodiment of the invention may be combined with an existing prior-art “stationary RFID reader” system by adjusting its control logic to operate along the lines described by the flow chart of FIG. 5. To execute this method, the system should have both stationary RFID readers at known locations, as in prior-art installations; and mobile data collection units like those discussed with reference to FIGS. 2 and 4. Both stationary and mobile readers may interact with the same tag, or assets may have multiple tags (one for each type of reader), provided that the system also has cross-referencing data to associate unique tag identifiers with asset identifiers.

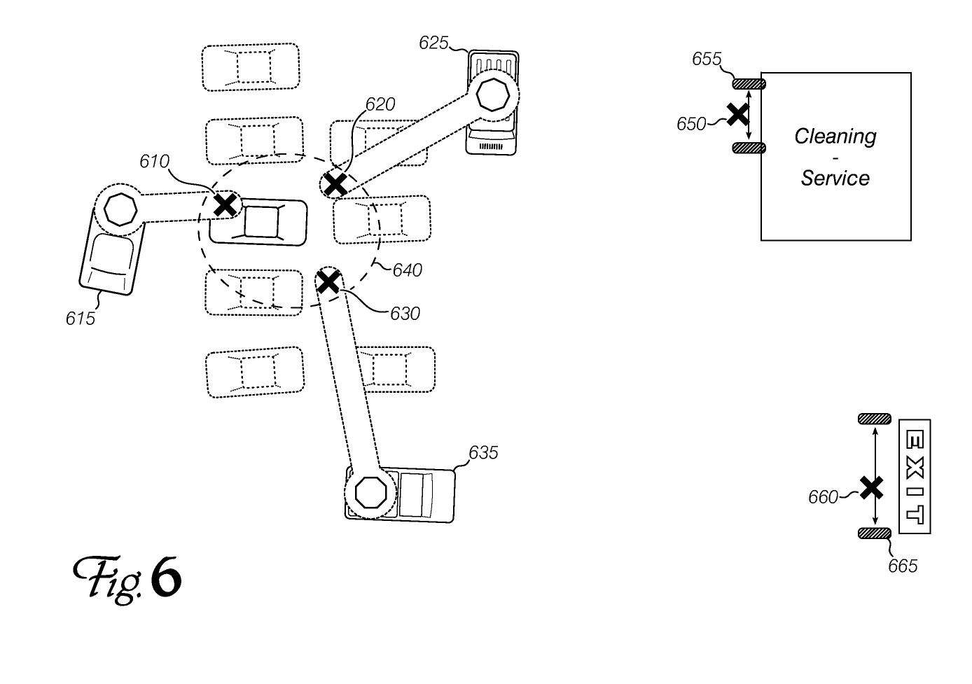

It is helpful (but not essential) for the system to be initialized with reliable asset location information (500). This information may be collected through a traditional manual inventory (for example, workers may make row-by-row inspections of each vehicle to confirm that the RFID tag(s) match the VIN numbers in the database). Then, during normal operation, RFID-tag detections from both mobile and stationary readers are received (510) and a history of recent detections for each tag may be maintained (520). Each detection may affect the system's estimate of where the tagged asset may be found, by increasing a confidence level that it is in a particular place (530), reducing the confidence level (540), replacing the location prediction with a new location (550), or clearing the location information to indicate that the system no longer knows where the asset is (560). The logic to decide which action to take is difficult to represent clearly in flow-chart form; it is easier to describe in narrative, with reference to the sample set of detection events shown in FIG. 6. There, bold X marks indicate estimates of asset location made when an RFID response is received from a tagged asset. For example, marks 610, 620 and 630 correspond to detections made by mobile data collection units 615, 625 and 635, respectively. If these detections were made and reported in temporal sequence, with no intervening detections, then each detection would strengthen the system's confidence that the asset was actually located near 640, in the immediate vicinity of the marks.

In contrast, consider the system's state if detection 650, made by a stationary RFID reader 655, occurs between detections 610 and 620, or 620 and 630. Now, extrinsic information may be needed to produce a good estimate of current asset location. If RFID reader 655 is located somewhere vehicles are taken for brief periods (e.g., a washing and detailing bay, inspection, or perhaps minor mechanical service), then it is likely that detection 650 represents a temporary excursion, and that the vehicle was returned to its previous location near 640 (where subsequent mobile-unit detections 620 and/or 630 noted it to be).

On the other hand, if detection 650 occurred after all three detections 610, 620, 630; and particularly if a further detection 660 by entrance/exit RFID monitor 665 followed detection 650, then the system may severely reduce its confidence estimate that the tagged asset is near 640. Indeed, unless further detections occur, the system may report the asset's location as “unknown.” (Note that it is extremely useful for the system to receive “coming” or “going” information: if the asset leaves (or enters) the controlled and inventoried premises, the asset location database can be updated more effectively than if it is only known that the asset was observed near the entrance or exit.)

In any case, by maintaining a temporal history of detection events (times and location estimates), it may be possible to reconstruct a lost asset's motions and decide how best to search for it. For example, a vehicle that is regularly observed in a parking area, but then appears at the cleaning station, showroom and finally at the exit, may have been delivered to a customer; so a salesperson who completed a sale around that time may have more information. (E.g., the salesperson may have forgotten to remove the RFID tags, or to update the inventory system to reflect the sale and delivery of the vehicle.

An embodiment of the invention may be a machine-readable medium having stored thereon data and instructions to cause a programmable processor to perform operations as described above. In other embodiments, the operations might be performed by specific hardware components that contain hardwired logic. Those operations might alternatively be performed by any combination of programmed computer components and custom hardware components.

Instructions for a programmable processor may be stored in a form that is directly executable by the processor (“object” or “executable” form), or the instructions may be stored in a human-readable text form called “source code” that can be automatically processed by a development tool commonly known as a “compiler” to produce executable code. Instructions may also be specified as a difference or “delta” from a predetermined version of a basic source code. The delta (also called a “patch”) can be used to prepare instructions to implement an embodiment of the invention, starting with a commonly-available source code package that does not contain an embodiment.

In some embodiments, the instructions for a programmable processor may be treated as data and used to modulate a carrier signal, which can subsequently be sent to a remote receiver, where the signal is demodulated to recover the instructions, and the instructions are executed to implement the methods of an embodiment at the remote receiver. In the vernacular, such modulation and transmission are known as “serving” the instructions, while receiving and demodulating are often called “downloading.” In other words, one embodiment “serves” (i.e., encodes and sends) the instructions of an embodiment to a client, often over a distributed data network like the Internet. The instructions thus transmitted can be saved on a hard disk or other data storage device at the receiver to create another embodiment of the invention, meeting the description of a machine-readable medium storing data and instructions to perform some of the operations discussed above. Compiling (if necessary) and executing such an embodiment at the receiver may result in the receiver performing operations according to a third embodiment.

In the preceding description, numerous details were set forth. It will be apparent, however, to one skilled in the art, that the present invention may be practiced without some of these specific details. In some instances, well-known structures and devices are shown in block diagram form, rather than in detail, in order to avoid obscuring the present invention.

Some portions of the detailed descriptions may have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the preceding discussion, it is appreciated that throughout the description, discussions utilizing terms such as “processing” or “computing” or “calculating” or “determining” or “displaying” or the like, refer to the action and processes of a computer system or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, including without limitation any type of disk including floppy disks, optical disks, compact disc read-only memory (“CD-ROM”), and magnetic-optical disks, read-only memories (ROMs), random access memories (RAMs), eraseable, programmable read-only memories (“EPROMs”), electrically-eraseable read-only memories (“EEPROMs”), magnetic or optical cards, or any type of media suitable for storing computer instructions.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will be recited in the claims below. In addition, the present invention is not described with reference to any particular programming language. It will be appreciated that a variety of programming languages may be used to implement the teachings of the invention as described herein.

The applications of the present invention have been described largely by reference to specific examples and in terms of particular allocations of functionality to certain hardware and/or software components. However, those of skill in the art will recognize that RFID tracking of mobile assets distributed over an extended area can also be accomplished by software and hardware that allocate responsibility for the functions of embodiments of this invention differently than herein described. Such variations and implementations are understood to be captured according to the following claims.

I claim:

1. A Radio-Frequency Identification (“RFID”)-based asset-tracking system comprising:
an RFID tag attached to an asset;
a mobile RFID surveyor including an RFID reader to interact with the RFID tag and means for determining a location of the mobile RFID surveyor;
processing logic to correlate a signal from the RFID tag with the location of the mobile RFID surveyor; and
a database to store the location of the mobile RFID surveyor.

2. The RFID-based asset-tracking system of claim 1 wherein the means for determining a location of the mobile RFID surveyor is a Global Position System (“GPS”) receiver.

3. The RFID-based asset-tracking system of claim 1 wherein the means for determining a location of the mobile RFID surveyor is an ultrasonic triangulation system.

4. The RFID-based asset-tracking system of claim 1 wherein the means for determining a location of the mobile RFID surveyor is a scanner to read location marks on a surface near the mobile RFID surveyor.

5. The RFID-based asset-tracking system of claim 1 wherein the RFID reader comprises:
an amplifier to increase a power of an interrogation signal; and
an enhanced-sensitivity antenna to receive a response to the interrogation signal from the RFID tag.

6. The RFID-based asset-tracking system of claim 1 wherein the mobile RFID surveyor is an electric vehicle.

7. A method for maintaining an asset-location database comprising:
attaching a Radio-Frequency Identification (“RFID”) tag to an asset, said asset having a physical location near a plurality of other assets;
moving an RFID surveyor among the plurality of assets;
interrogating the RFID tag;
receiving a reply from the RFID tag;
obtaining an estimate of a position of the RFID surveyor when the reply is received; and
storing the position estimate in the asset-location database as a location of the asset having the RFID tag.

8. The method of claim 7, further comprising:
receiving a report of a detection of the RFID tag by a stationary RFID reader; and
updating the position estimate in the asset-location database according to a known position of the stationary RFID reader.

9. The method of claim 7 wherein the RFID tag is an active/passive RFID tag.

10. The method of claim 7 wherein the plurality of assets is distributed over an area whose linear dimensions exceed a reliable communication range between the RFID tag and the RFID surveyor.

11. The method of claim 7 wherein moving the RFID surveyor among the assets is driving a vehicle comprising the RFID surveyor through aisles of a parking lot.

12. The method of claim 7, further comprising:
receiving a second reply from the RFID tag when the RFID surveyor is at a second, different position;
obtaining a second estimate of the second, different position; and
adjusting the location of the asset having the in the asset-location database according to second estimate.

13. An inventory control and management system for tracking locations of a plurality of vehicles on a lot comprising:
an active/passive Radio Frequency Identification (“RFID”) tag attached to each of the plurality of vehicles, each such RFID tag having a unique identification number among the plurality of RFID tags and each unique RFID identification number associated with a unique identifier of its corresponding vehicle in a computer database;
a mobile RFID survey vehicle having an RFID reader to communicate with RFID tags and a Global Positioning System (“GPS”) receiver to obtain an estimate of a location of the survey vehicle;
a programmable processor to cause the RFID reader to communicate with RFID tags of vehicles near the survey vehicle and correlate the unique identification number of the RFID tags with the estimate of the location of the survey vehicle; and
communication means to report the unique RFID tag numbers and the location estimates for incorporation in the computer database.

14. The inventory control and management system of claim 13, further comprising:
a stationary RFID reader to communicate with an RFID tag of a vehicle of the plurality of vehicles if the vehicle passes near the stationary RFID reader; and
a communication interface for the stationary RFID reader to report the unique RFID tag number of the vehicle for incorporation in the computer database.

15. The inventory control and management system of claim 13 wherein the communication means is a cellular telephone data link.

16. The inventory control and management system of claim 13 wherein the communication means is a WiFi interface.

17. The inventory control and management system of claim 13, further comprising:
a temporary storage cache at the survey vehicle to store the unique RFID tag numbers and the location estimates, and wherein
the communication means is a Universal Serial Bus (“USB”) link between the survey vehicle and a stationary computer that accesses the computer database.

18. The inventory control and management system of claim 13, further comprising:
a user interface at the mobile RFID survey vehicle to accept an identification number of a vehicle to be found; and
an output device to indicate to an operator of the mobile RFID survey vehicle whether the mobile RFID survey vehicle is moving closer to or further away from the vehicle to be found.

19. The inventory control and management system of claim 18 wherein the output device is to indicate a range to the vehicle to be found by changing a pitch of an audible tone.

20. The inventory control and management system of claim 18 wherein the output device is to indicate a range to the vehicle to be found by changing a frequency of a repeating intermittent tone.
